(19) United States
(12) Patent Application Publication
(10) Pub. No.: US 2010/0318496 A1
(43) Pub. Date: Dec. 16, 2010

(54) System and Method for End-User Archiving

(76) Inventor: Bruce R. Backa, Incline Village, NV (US)

Correspondence Address: SAMPSON & ASSOCIATES, P.C., 50 CONGRESS STREET, BOSTON, MA, 02109, US

(21) Appl. No.: 12/793,356

(22) Filed: Jun. 3, 2010

Related U.S. Application Data
(60) Provisional application No. 61/186,214, filed on Jun. 11, 2009.

(51) Int. Cl. G06F 17/30

(52) U.S. Cl. 707/661; 707/E17.01

(57) ABSTRACT

A system and method for facilitating data archiving by end-users. End-users perform an action, such as a right-click on a computer mouse, enabled by a file selection application, to select files to be archived. The file selection application will in turn invoke an application which will translate the intended action into a set of instructions for a particular data archiving product in order for that application to archive data as intended.

### TECHNICAL FIELD

The present invention relates to a system and method for data archiving by end-users that enables end-users to quickly and easily designate files for archiving and have those files archived.

### BACKGROUND INFORMATION

It is important for companies to find cost effective ways to manage their storage environment. Although it may seem that storage is inexpensive, 80% or more of the total cost of storage ownership is in managing and administering that storage. Storage is growing at about 50% per year, along with the cost to manage that storage. Many companies attempt to manage costs by having various tiers of storage, with different costs for each of these tiers. Many companies take a simplistic and costly approach of “archive everything over x days” from the higher cost storage tiers to the lower cost tiers. But this still tends to result in much greater costs than necessary as it does not get those involved who can determine what should be archived vs. what can be eliminated.

Many storage software vendors provide solutions that will archive data. However they generally require centralized administration, e.g., by system administrators or other IT personnel, who initiate an archive application to implement relatively broad-based archival schemes such as looking for files over “x” days old and then archive this data. This is a very “blunt instrument” approach. These solutions do not involve users who are the ones who best know the business value of particular files.

Accordingly, what is needed is a cost-effective system and method for data archiving that enables convenient selection and differentiation between files that should and should not be archived, and to effect archival of those selected files.

### SUMMARY

Embodiments of the present invention include the following components:
an application that allows end-users to right-click on selected files and designate them for archiving;
a mechanism to translate the intended action into a set of instructions for a particular data archiving product; and
a mechanism to satisfy the requirements of network security and convey the instructions to the data archiving product.

### BRIEF DESCRIPTION OF THE DRAWINGS

These and other features and advantages of the present invention will be better understood by reading the following detailed description, taken together with the drawings wherein:

FIG. 1 is block diagram of a representative embodiment implementing the system and method of the present invention.

### DETAILED DESCRIPTION OF THE PREFERRED EMBODIMENTS

The present inventors have recognized that at least two aspects are needed to implement truly cost effective data storage archive management—automation and the participation of end-users. Getting end-users involved in archiving files and eliminating unwanted files may greatly reduce costs. This is because end-users are generally the best ones to know what should be archived or eliminated, vs. a broad based “archive everything over x days old” approach.

Briefly, embodiments of the present invention provide end-users with the ability to conveniently select files, e.g., by right-click, to have those files archived. For the purposes of this disclosure, the term “right-click” will be understood to encompass substantially any user interface mechanism that enables the end-user to quickly and easily activate an application and select files for archiving. Right-click may be accomplished by, but is not limited to, a computer mouse action such as a click, or on a keyboard, actuation of specific key(s) such as a “hot key”, “Alt. key” or combination of keys.

As used herein, the terms “computer” and “end-user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine” and the like are intended to refer to a computer-related component, including hardware, software, and/or software in execution. For example, an engine may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

The system and method embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or Oracle.

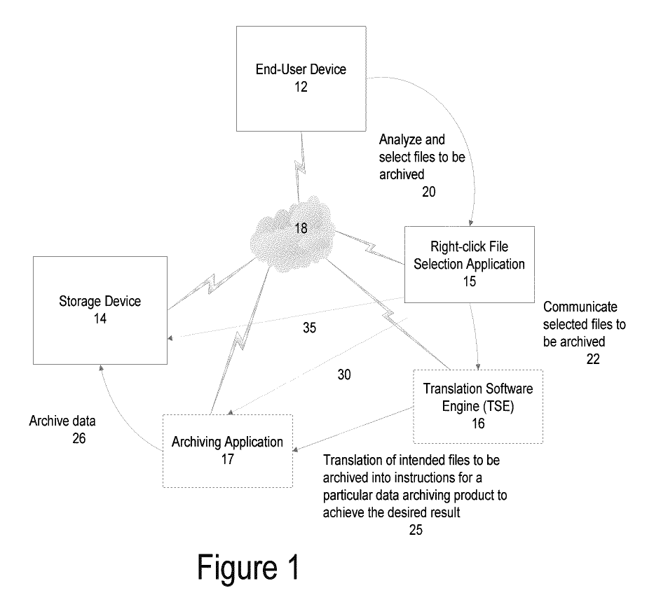

Embodiments of the present invention will be explained in connection with a system 10, FIG. 1, including an end-user device 12, a storage device 14, a right-click file selection application 15 that allows end-users to right-click on a file(s) and designate the selection for archiving, a user-driven on-demand translation software engine (TSE) 16, and a file archiving application 17. The end-user device 12, storage device 14, and the on-demand server that holds the TSE 16, are coupled together over a local or wide area network by means of a network communication path 18. In particular embodiments, the end-user device 12 may be any form of computing or data processing device requiring access to data stored on the storage device 14. The Right-click File Selection Application 15 may reside directly on the end-user device 12. This application 15 may take various forms including, but not limited to, an add-in to the Microsoft Windows Explorer interface, or a standard web browser based application that works with web browsers such as, but not limited to, Microsoft Internet Explorer (IE) and Mozilla Firefox. The TSE 16 is an application configured to effectively translate actions taken at the Right-Click File Selection Application 15 into instructions, usable by a particular archiving application 17. TSE 16 may also handle appropriate security requirements, e.g., to ensure that the particular user at device 12 has requisite permissions, etc. In particular exemplary embodiments, TSE 16 may include the NTP Software ODA™ engine commercially available from NTP Software, Inc. (Nashua, N.H., USA). TSE 16 may be located on an on-demand server that may perform other functions and provide other features to the network. The archiving application 17 may include any number of conventional archiving applications e.g., of the type generally requiring central administration by IT personnel (e.g., system administrators). A non-limiting example of an archiving application suitable for use in connection with embodiments of the present invention includes the Symantec Enterprise Vault archiving application (Symantec Corporation, Cupertino Calif., USA). Archiving application 17 may reside on an archiving application server that is separate from TSE 16, or alternatively, application 17 and TSE 16 may reside on the same server. Storage device 14 may include any number of storage devices, including, but not limited to, Network Attached Storage (NAS) such as those available from EMC Corporation (Hopkinton, Mass., USA) and NetApp (Sunnyvale, Calif., USA), Storage Area Network (SAN) devices such as, but not limited to, those from EMC Corporation (Hopkinton, Mass., USA), and direct attached storage devices (DAS) such as, but not limited to, devices running the Microsoft Windows Server operating system.

In operation, the end-user takes action 20 to select files to be archived by utilizing the Right-Click File Selection Application 15. This application 15 notifies 22 the TSE 16 of what files and folder(s) are the basis for desired results for archiving. Thereafter the TSE 16 translates 25 the intended actions into instructions for a particular archiving application 17 to archive data 26 to storage device 14 based on files selected by the end-user. In particular embodiments, the TSE handles the appropriate security requirements as discussed above. Moreover, the TSE 16 may also allow for optional configuration settings to be set (e.g., pre-set) by system administrators. Examples of such optional configuration settings might be that files selected by the end-user for archiving will only be archived at night, or perhaps that no MP3 files will be allowed to be archived.

It should be noted that in variations of the foregoing embodiments, the TSE 16 is not required to be a separate module, but rather, may be integrated into the Right-click File Selection Application 15, which may thus handle the appropriate security requirements, and translate the files selected by the end-user into instructions 30 for the archiving application 17 to archive the files. In still further variations of these embodiments, both the TSE 16 and the archiving application 17 may be integrated into the Right-click File Selection Application 15, which may thus translate the files selected by the end-user into archiving instructions 35 that can be understood directly by the operating system or related application programming interface (API) of the storage device 14, (an example of this is an API provided by NetApp which allows archiving instructions to be given to its NAS devices).

An example of end-user archiving using right-click in accordance with the present invention, might be that an end-user is using Microsoft Windows Explorer, or a web browser, and right-clicks on “big.doc”, and “waste.xls”, to be archived from the “user1” folder on a storage device. Knowing what files the user selected based on communication from the Right-click File Selection Application 15, the TSE 16 translates the desired result into commands to the archiving application 17 to archive only the files the user selected (“big.doc” and “waste.xls” in this example). These instructions for the archiving application may be created substantially in real-time (e.g., on-demand), or may be created and executed at a later time.

One skilled in the art should recognize, in light of the present disclosure, that the particular archiving instructions generated by TSE 16, or the Right-click File Selection Application 15 in the variations discussed above, may be tailored to the capabilities of the particular archiving application 17 or storage device 14, in combination with the particular files selected using the Right-click File Selection Application 15, so as to achieve the desired archiving results as close as practical, within the limitations of the archiving application 17 or storage device 14. In this regard, in some embodiments, archiving application 17 may enable individual files to be archived directly, e.g., by name, while other archiving applications may require an indirect approach including a more complex series of instructions configured to filter out substantially all but the selected file(s).

Thus, in particular representative embodiments, to enable end-user data archiving using right-click in accordance with the present invention, the following components are provided:
an application that allows end-users to right-click on a file(s) and designate the selection for archiving
a mechanism to translate the intended action into a set of instructions for a particular data archiving product
a mechanism to satisfy the requirements of network security and convey the instructions to the data archiving product

Other embodiments include a system for providing end-user data archiving using right-click, including:

an end-user device including a right-click file selection software application configured to enable an end-user to generate file selections for archiving;

an on-demand server communicably coupled to the end-user device and including a user-driven on-demand translation software engine (TSE) configured to receive the file selections and to translate the file selections into instructions usable by an archiving software application;

an archiving application server, communicably coupled to the on-demand server and including an archiving application configured to execute the archiving instructions to archive the file selections on a storage device communicably coupled to the archiving application server.

The TSE may be configured to handle appropriate security requirements. However, in variations of the above embodiments, the TSE may be integrated into the right-click file selection software application, which may thus handle the appropriate security requirements and translate the end-user file selections into instructions for an archiving software application.

In variations of the above embodiments, both the TSE and the archiving application are integrated within the right-click file selection software application, so that the right-click file selection module is configured to translate the end-user file selections into instructions that can be understood directly by the storage device's operating system and/or by the storage device's application programming interface (API).

In variations of the above embodiments, the storage device includes a network attached storage (NAS) device.

In variations of the above embodiments, the storage device includes a storage area network (SAN) device.

In variations of the above embodiments, the storage device includes a direct attached storage (DAS) device.

In a further variation of the above embodiments, the on-demand server may include the archiving application server.

In still another variation of the foregoing embodiments, the TSE is configured to monitor and enforce permissions, wherein the TSE is configured to determine whether the file selections are compliant with one or more established policies including whether or not a particular end-user is authorized to archive particular files on the storage device.

Furthermore, embodiments of the present invention include a computer program code-based product, which includes a computer readable storage medium having program code stored therein which can be used to instruct a computer to perform any of the functions, methods and/or modules associated with the present invention. The computer storage medium includes any of, but not limited to, the following non-transitory media: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having described the invention, what is claimed is:

1. A system for providing end-user data archiving using right-click, including:
a right-click file selection module configured to enable an end-user to generate file selections for archiving;
an on-demand module communicably couplable to the file selection module and including a user-driven on-demand translation engine (TSE) configured to receive the file selections and to translate the file selections into instructions usable by an archiving software application; and
an archiving application module, communicably couplable to the on-demand module, the archiving application module configured to execute the archiving instructions to archive the file selections on a storage device communicably coupled to the archiving application module.

2. The system of claim 1, wherein the file selection module is configured for being integrated within an end-user device.

3. The system of claim 2, wherein the file selection module comprises computer readable instructions disposed on a non-transitory computer usable medium.

4. The system of claim 3, wherein the on-demand module comprises an on-demand server, and the TSE includes computer readable instructions disposed on a non-transitory computer usable medium.

5. The system of claim 4, wherein the archiving application module comprises an archiving application server, and an archiving application disposed thereon, the archiving application including computer readable instructions disposed on a non-transitory computer usable medium to execute the archiving instructions to archive the file selections on a storage device communicably coupled to the archiving application module.

6. The system of claim 5, wherein the on-demand server includes the archiving application server.

7. The system of claim 1, wherein the TSE is configured to handle security requirements.

8. The system of claim 7, wherein the TSE is configured to monitor and enforce permissions, and to determine whether the file selections are compliant with one or more established policies including whether or not a particular end-user is authorized to archive particular files on the storage device.

9. The system of claim 7, wherein the TSE is incorporated within the file selection module.

10. The system of claim 9, wherein the right-click file selection module is configured to handle security requirements, and to translate the end-user file selections into instructions for the archiving application module.

11. The system of claim 9, wherein the archiving application is incorporated within the file selection module.

12. The system of claim 11, wherein the right-click file selection module is configured to translate the end-user file selections into instructions that can be understood directly by the storage device's operating system.

13. The system of claim 11, wherein the right-click file selection module is configured to translate the end-user file selections into instructions that can be understood directly by the storage device's application programming interface (API).

14. The system of claim 1, wherein the storage device includes a network attached storage (NAS) device.

15. The system of claim 1, wherein the storage device includes a storage area network (SAN) device.

16. The system of claim 1, wherein the storage device includes a direct attached storage (DAS) device.

17. The system of claim 1, wherein the TSE comprises the NTP Software ODA engine.

18. The system of claim 17, wherein the archiving module comprises the Symantec Enterprise Vault.

19. The system of claim 1, wherein the TSE is configured for enabling archiving settings to be pre-set.

20. A method of end-user data archiving using right-click, the method comprising:
(a) enabling an end-user to generate selection instructions for files to be archived by utilizing a Right-Click File Selection Module;
(b) receiving the selection instructions at a Translation Software Engine (TSE);
(c) translating, with the TSE, the selection instructions into archival instructions for a predetermined archiving application module;
(d) handling, with the TSE, security requirements associated with the selection instructions; and
(e) transmitting, with the TSE, the archival instructions to the archiving application module.

21. The method of claim 19, comprising receiving, at the TSE, configuration settings from a system administrator.

22. The method of claim 20, wherein said enabling (a) comprises enabling an end-user to generate selection instructions for files to be archived by utilizing a Right-click File Selection Module integrated within an end-user device.

23. The method of claim 22, wherein the file selection module comprises computer readable instructions disposed on a non-transitory computer usable medium.

24. The method of claim 23, being effected with a system in which the TSE includes an on-demand server having computer readable instructions disposed on a non-transitory computer usable medium.

25. The method of claim 24, wherein said transmitting (e) comprises transmitting the archival instructions to an archiving application module including an archiving application server, and an archiving application disposed thereon, the archiving application including computer readable instructions disposed on a non-transitory computer usable medium to execute the archiving instructions to archive the file selections on a storage device communicably coupled to the archiving application module.

26. The method of claim 25, being effected with a system in which the on-demand server includes the archiving application server.

27. The method of claim 20, being effected with a system in which the TSE is configured to handle security requirements.

28. The method of claim 27, being effected with a system in which the TSE is configured to monitor and enforce permissions, and to determine whether the file selections are compliant with one or more established policies including whether or not a particular end-user is authorized to archive particular files on the storage device.

29. The method of claim 27, being effected with a system in which the TSE is incorporated within the file selection module.

30. The method of claim 29, being effected with a system in which the right-click file selection module is configured to handle security requirements, and to translate the end-user file selections into instructions for the archiving application module.

31. The method of claim 29, being effected with a system in which the archiving application is incorporated within the file selection module.

32. The method of claim 31, being effected with a system in which the right-click file selection module is configured to translate the end-user file selections into instructions that can be understood directly by the storage device's operating system.

33. The method of claim 31, being effected with a system in which the right-click file selection module is configured to translate the end-user file selections into instructions that can be understood directly by the storage device's application programming interface (API).

34. The method of claim 20, being effected with a system in which the storage device includes a network attached storage (NAS) device.

35. The method of claim 20, being effected with a system in which the storage device includes a storage area network (SAN) device.

36. The method of claim 20, being effected with a system in which the storage device includes a direct attached storage (DAS) device.

37. The method of claim 20, being effected with a system in which the TSE comprises the NTP Software ODA engine.

38. The method of claim 37, being effected with a system in which the archiving module comprises the Symantec Enterprise Vault.

39. A system for providing end-user data archiving using right-click, including:
an end-user device including a right-click file selection software application configured to enable an end-user to generate file selections for archiving;
an on-demand server communicably coupled to the end-user device and including a user-driven on-demand translation software engine (TSE) configured to receive the file selections and to translate the file selections into instructions usable by an archiving software application; and
an archiving application server, communicably coupled to the on-demand server and including an archiving application configured to execute the archiving instructions to archive the file selections on a storage device communicably coupled to the archiving application server.
